(19) United States
(12) Patent Application Publication
(10) Pub. No.: US 2015/0246316 A1
(43) Pub. Date: Sep. 3, 2015

(54) FILTRATION SYSTEMS HAVING FLOW-REVERSING SUBSYSTEMS AND ASSOCIATED METHODS

(71) Applicant: CARDEN WATER SYSTEMS, LLC, Phoenix, AZ (US)

(72) Inventor: Dennis Chancellor, Gilbert, AZ (US)

(73) Assignee: CARDEN WATER SYSTEMS, LLC, Phoenix, AZ (US)

(21) Appl. No.: 14/194,372

(22) Filed: Feb. 28, 2014

(51) Int. Cl. B01D 65/02; G05D 7/06; B01D 61/08; B01D 61/02; B01D 61/12

(52) U.S. Cl. CPC B01D 65/02; B01D 61/025; B01D 61/12; B01D 61/08; G05D 7/0629; B01D 2321/04; B01D 2321/40; B01D 2315/18

(57) ABSTRACT

Filtration system including flow-reversing subsystems are provided, as are methods for separating feed streams into reject streams and permeate streams. In one embodiment, the filtration system includes a reversible flow loop having an inlet configured to receive a pressurized feed stream. At least one filter unit is positioned in the reversible flow loop and configured to separate the pressurized feed stream into a permeate stream and a reject stream. A flow-reversing subsystem is further positioned in the reversible flow loop and is operable in: (i) a forward flow mode wherein the flow-reversing subsystem pressurizes the feed stream to flow through the reversible flow loop in a forward flow direction, and (ii) a reverse flow mode wherein the flow-reversing subsystem pressurizes the feed stream to flow through the reversible flow loop in a reverse flow direction opposite the forward flow direction.

### TECHNICAL FIELD

Embodiments of the present invention relate generally to filtration systems and, more particularly, to fluid filtration systems having flow-reversing subsystems and methods for controllably reversing the flow of a feed stream to deter the accumulation of contaminants within one or more filter units.

### BACKGROUND

Reverse osmosis water filtration systems and other fluid filtration systems use porous filter elements to separate a feed stream into a reject stream and a purified permeate stream. Over time, the filter elements become saturated with solid contaminants removed from the feed stream, which lodge within the filter element pores. Saturation of the filter elements reduces filter performance, increases required pressure differentials, and may eventually necessitate replacement of the filter elements. Backflushing can be performed periodically to dislodge the solid matter from the filter element pores and thus deter filter element contamination. Backflushing is ideally performed in-situ to avoid shutdown of the filtration system. In-situ backflushing subsystems have consequently been developed for this purpose. Several examples of in-situ backflushing subsystems are described in co-pending U.S. application Ser. No. 13/744,267, entitled “FILTER BACKFLUSH SYSTEM FOR ENTRAINED FILTRATION ELEMENTS,” filed Jul. 18, 2013, and assigned to the assignee of the present application, the contents of which are hereby incorporated by reference. However, while able to deter filter element saturation and improve filter lifespan, conventional backflushing subsystems remain limited in several respects. For example, conventional backflushing subsystems often rely on multiple valves and relatively complex plumbing to achieve the desired flow reversal during backflushing. As a result, conventional backflushing subsystems are often undesirably complex, bulky, energy inefficient, and costly to produce and operate.

It is thus desirable to provide embodiments of a filtration system including a flow-reversing subsystem, which has a reduced complexity, part count, and cost as compared to conventional backflushing subsystem. Ideally, embodiments of such a flow-reversing subsystem would enable feed stream flow reversal in a highly controllable manner and without the usage of valves, complex plumbing, and other such components to improve filtration system efficiencies. It would also be desirable to provide embodiments of a method for operating such a filtration system and flow-reversing subsystem. Finally, it would be desirable to provide embodiments of a flow-reversing subsystem, which could utilized in conjunction with fluid-driven devices other than filtration units, such as certain types of mining equipment. Other desirable features and characteristics of the present invention will become apparent from the subsequent Detailed Description and the appended Claims, taken in conjunction with the accompanying Drawings and the foregoing Background.

### BRIEF SUMMARY

Filtration systems including flow-reversing subsystems are provided. In one embodiment, the filtration system includes a reversible flow loop having an inlet configured to receive a pressurized feed stream. At least one filter unit is positioned in the reversible flow loop and configured to separate the pressurized feed stream into a permeate stream and a reject stream. A flow-reversing subsystem is further positioned in the reversible flow loop and is operable in: (i) a forward flow mode wherein the flow-reversing subsystem pressurizes the feed stream to flow through the reversible flow loop in a forward flow direction, and (ii) a reverse flow mode wherein the flow-reversing subsystem pressurizes the feed stream to flow through the reversible flow loop in a reverse flow direction opposite the forward flow direction.

Flow-reversing subsystems are further provided. In one embodiment, the flow-reversing subsystem includes a reversible flow loop having an inlet configured to receive a pressurized feed stream. A forward flow pump is fluidly positioned in the reversible flow loop and, when energized, directs the pressurized feed stream through the reversible flow loop in a forward flow direction. A reverse flow pump is further fluidly positioned in the reversible flow loop and, when energized, directs the pressurized feed stream through the reversible flow loop in a reverse flow direction substantially opposite the forward flow pump. A controller is operably coupled to the forward flow pump and to the reverse flow pump. The controller energizes the forward flow pump in the forward flow mode and energizes the reverse flow pump in the reverse flow mode.

Methods for separating feed streams into permeate streams and reject streams are still further provided. In one embodiment, the method includes the step or process of directing a feed stream in a first direction around a reversible flow loop in which at least one filter unit is positioned, while collecting a permeate stream from the filter units and while withdrawing the reject stream from the reversible flow loop at a first location. One or more pumps are controlled to reverse the direction of the feed stream flow around the reversible flow loop, while continuing to collect the permeate stream from the filter units and while withdrawing the reject stream from the reversible flow loop at a second location different than the first location.

### BRIEF DESCRIPTION OF THE DRAWINGS

At least one example of the present invention will hereinafter be described in conjunction with the following figures, wherein like numerals denote like elements, and:

FIGS. 1 and 2 are schematics of a filtration system including a flow-reversing subsystem operating in forward flow and reverse flow modes, respectively, as illustrated in accordance with an exemplary embodiment of the present invention; and

FIG. 3 is a schematic of a filtration system including a flow-reversing subsystem, as illustrated in accordance with a further exemplary embodiment of the present invention.

For simplicity and clarity of illustration, the drawing figures illustrate the general manner of construction, and descriptions and details of well-known features and techniques may be omitted to avoid unnecessarily obscuring the exemplary and non-limiting embodiments of the invention described in the subsequent Detailed Description. It should further be understood that features or elements appearing in the accompanying figures are not necessarily drawn to scale unless otherwise stated. For example, the dimensions of certain elements or regions in the figures may be exaggerated relative to other elements or regions to improve understanding of embodiments of the invention.

### DETAILED DESCRIPTION

The following Detailed Description is merely exemplary in nature and is not intended to limit the invention or the application and uses of the invention. Furthermore, there is no intention to be bound by any theory presented in the preceding Background or the following detailed description.

Fluid filtration systems including flow-reversing subsystem are described herein, as are methods for separating feed streams into reject and permeate streams. Notably, the below-described flow-reversing subsystems enable the flow of a feed stream supplied to one or more filters units to be periodically reversed (that is, cycled between forward flow and reverse flow directions) in a controllable and non-abrupt manner. By periodically reversing the flow of the feed stream supplied to the filter units, the accumulation of particulate matter, molecular matter, or other contaminants within the filter units can be minimized to improve filter element life; e.g., in certain cases, an improvement of four to five times filter element life can be achieved. This represents a significant improvement over conventional filtration systems. Additionally, minimizing debris accumulation within the filter elements may improve filter efficacy, while reducing the overall energy requirements of the filtration system. In preferred embodiments, the flow-reversing subsystem provides the desired flow reversal without reliance on valves and complex plumbing networks. As a result, embodiments of the filtration system can be produced to include fewer (if any) valves further reducing system costs, operating pressures, and energy requirements. In a general sense, the flow-reversing subsystems described herein may be regarded as improved backflushing subsystems. However, in contrast to backflushing systems wherein backflushing is performed abruptly over a relatively short time period (e.g., on the order of a few seconds), embodiments of the flow-reversing subsystems preferably switch between forward and reverse flow modes periodically, with the subsystem operating in each mode for an extended period of time on the order of, for example, several minutes to several hours.

In preferred embodiments, the filtration system is implemented as a water filtration system and, more preferably, as a Reverse Osmosis (RO) filtration system. In such embodiments, the feed stream may be a contaminated water stream, while the filter units may be cross-flow RO filter units. This notwithstanding, it is emphasized that the filtration system can be utilized to filter and thereby purify various different types of fluids, including both liquids and gasses. For example, the filtration system may be utilized to purify chemical and hydrocarbon streams in at least some implementations. Additionally, embodiments of the filtration system described herein can employ various different types of filter units, as selected based upon the type of feed stream to be purified, the minimum permissible contaminant size (as determined by filter pore size), and other such parameters. Thus, as appearing herein, the term “filter element” is defined to include various different types of porous media, structures, or membranes including, but not limited to, spiral-wound filters, solid tubular filters (e.g., ceramic, polymer, or other tubes having a controlled porosity), charcoal filters, paper filters, and the like. The filter elements described herein can be of any type, size, and configuration suitable to removing solid contaminants from a feed stream and to produce a permeate stream, such as a purified water stream, as generally described below.

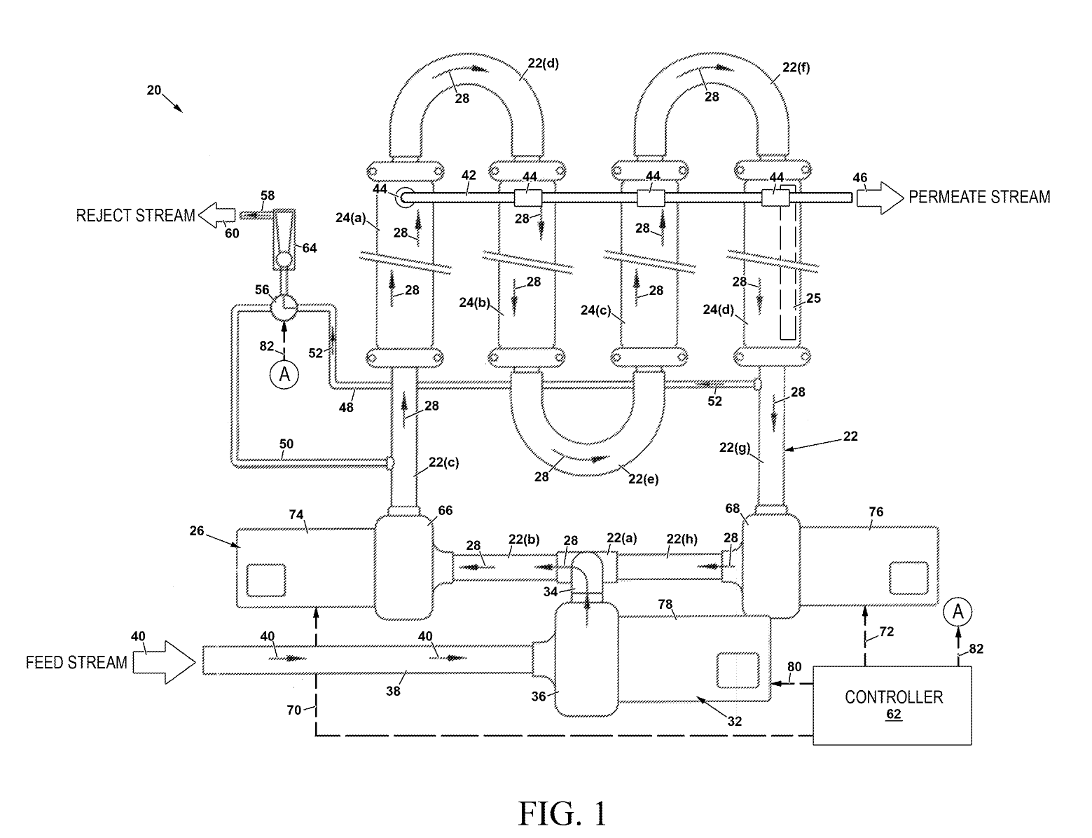

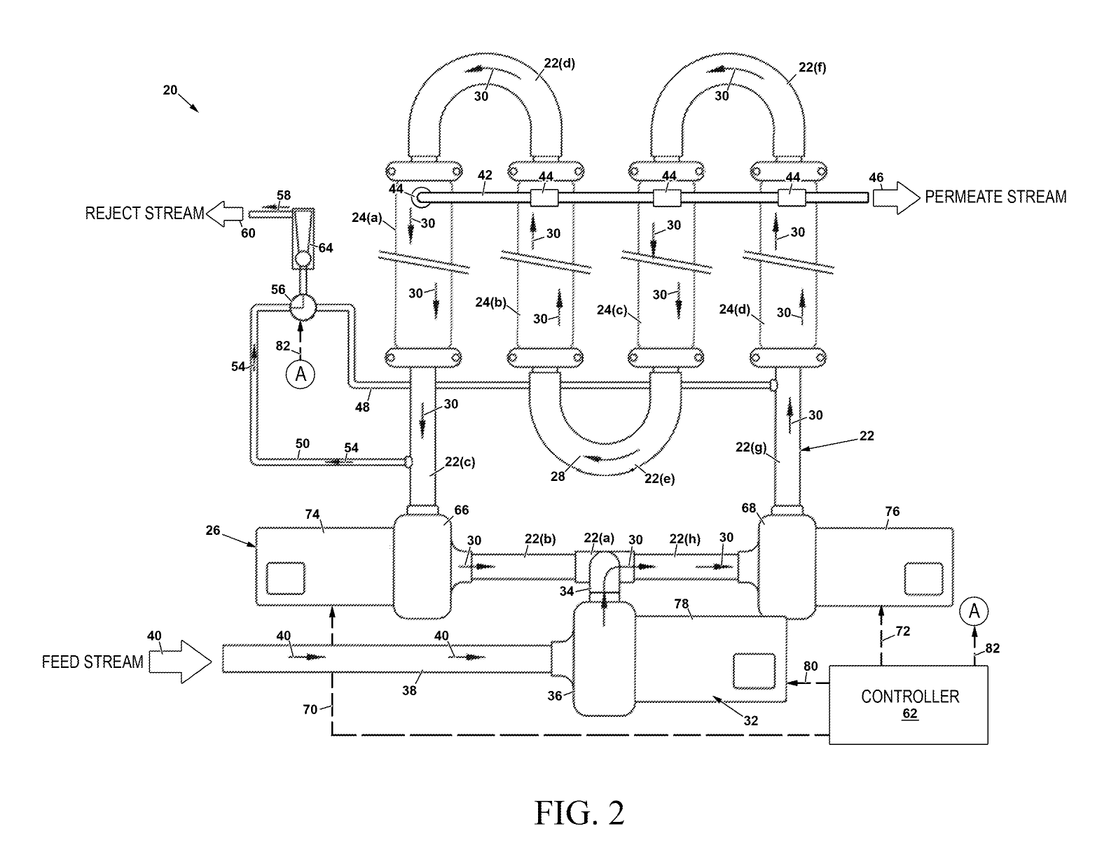

FIGS. 1 and 2 are schematics of a filtration system 20, as illustrated in accordance with an exemplary embodiment of the present invention. Filtration system 20 includes a number of conduits 22(a)-22(h), which are fluidly coupled together to form reversible flow loop 22. Conduits 22(a)-22(h) can be pipes, hoses, or any other component or structure having flow passages therethrough suitable for conducting a fluid under pressure. One or more filter units 24 are positioned in reversible flow loop 22. In the illustrated example, filtration system 20 includes four filters units 24(a)-(d), which are fluidly coupled in series by conduits 22(d)-(f). However, filtration system 20 may include a greater or lesser number of filter units in further implementations, which may be fluidly coupled in parallel, in series, or a series-parallel combination. For example, in further embodiments, filtration system 10 may include multiple banks of filter units, which are fluidly coupled in parallel and which contain two or more filter units fluidly coupled in series. In preferred embodiments, filter units 24 are cross-flow RO filter units, which each include vertically-oriented pressure vessel (as generally shown in FIGS. 1 and 2) containing one or more vertically-oriented RO filter elements. The vertically-oriented RO filter elements can be, for example, a number of solid tubular filters (one of which is illustrated in phantom in FIG. 1 and identified by reference numeral “25”), which are disposed within the pressure vessels in an annular array and which may range from about one to about six meters in length. This notwithstanding, it is emphasized that filter units 24 can each assume the form of any filtration device, regardless of design or orientation, containing at least one filter element and capable of separating a feed stream into a reject stream and a permeate stream, as described below.

A pump-driven, flow-reversing subsystem 26 is further positioned in reversible flow loop 22. Flow-reversing subsystem 26 is operable in at least two modes: a forward flow mode (FIG. 1) and a reverse flow mode (FIG. 2). In the forward flow mode (FIG. 1), flow-reversing subsystem 26 pressurizes the fluid within reversible flow loop 22 to flow through flow loop 22 and through filter units 24 in forward flow direction, as indicated in FIG. 1 by arrows 28. Conversely, in the reverse flow mode (FIG. 2), flow-reversing subsystem 26 pressurizes the fluid within reversible flow loop 22 to flow through flow loop 22 and through filter units 24 in a reverse flow direction, as indicated in FIG. 2 by arrows 30. In contrast to other known backflushing systems, flow-reversing subsystem 26 is able to transition between the forward flow mode (FIG. 1) and the reverse flow mode (FIG. 2) without the usage of valves to redirect or reroute fluid flow within loop 22. The manner in which flow-reversing subsystem 26 is able to accomplish such a valveless transition in flow directions is described in more detail below.

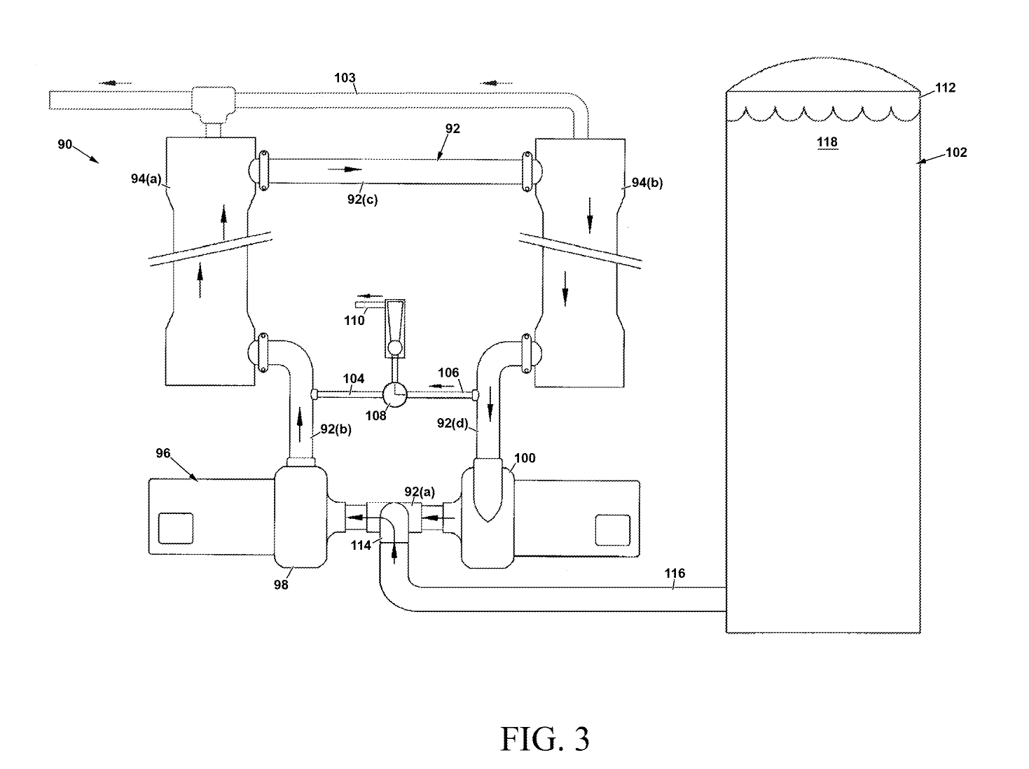

A pressurized feed stream source 32 is fluidly coupled to an inlet 34 of flow loop 22 and, during operation of system 20, supplies a pressurized feed stream thereto. In the exemplary embodiment shown in FIGS. 1 and 2, inlet 34 is defined by a three-way conduit 22(a) included within flow loop 22. Conduit 22(a) may also be referred to as a “blending tee” herein as fresh feed supplied by feed stream source 32 continually mixes with a recycled portion of the reject stream within conduit 22(a) during operation of system 20. Pressurized feed stream source 32 can assume any form suitable for providing a feed stream to flow loop inlet 34 at a predetermined pressure or range of pressures. For example, pressurized feed stream source 32 can assume the form of a liquid column providing a static head and held by a standpipe, a storage tank, or other vessel, as described more fully below in conjunction with FIG. 3. Alternatively, as generally illustrated in FIGS. 1 and 2, pressurized feed stream source 32 may include a main pump 36, which draws feed from a supply conduit 38 and then supplies the feed to flow loop inlet 34 at a controlled pressure (as indicated by arrows 40). Reversible low loop 22 directs the pressurized feed stream through filter units 24, which separate the feed stream into a reject stream and a permeate stream. The permeate stream discharged by each filter unit 24 is collected by a permeate conduit 42, which is fluidly joined to the respective sidewall outlets of filter units 24 by a number of couplings 44. Finally, as indicated in FIGS. 1 and 2 by arrow 46, the cumulative permeate stream may be withdrawn from filter system 20, whether as a final product or as an intermediate product subject to additional downstream processing.

As filter units 24 are coupled in flow series, the reject stream discharged by each filter unit 24 is supplied to the subsequent downstream filter unit 24 until the final unit 24 in the flow series is reached. The impurity concentration of the reject stream increases at each stage of filtration. The last filter unit 24 in the series then discharges the highly concentrated reject stream into reversible flow loop 22. First and second permeate drain lines 48 and 50 are fluidly coupled to reversible loop 22 to remove a portion of the highly concentrated reject stream discharged from the final filter unit 24 in the flow series. For example, a first permeate drain line 48 (referred to herein as the “forward drain line”) may be utilized to remove a portion of the reject stream discharged by final filter unit 24(a) in flow series when flow-reversing subsystem 26 operates in the forward flow mode, as indicated in FIG. 1 by arrows 52. Similarly, a second permeate drain line 48 (referred to herein as the “reverse drain line”) removes a portion of the reject stream discharged by final filter unit 24(d) when flow-reversing subsystem 26 operates in the forward flow mode, as indicated in FIG. 2 by arrows 54.

To prevent undesired siphoning of the feed stream upstream of filter units 24, fluid flow through drain lines 48 and 50 is selectively blocked or impeded depending upon the particular mode in which flow-reversing subsystem 26 is operating. In this regard, a flow control valve 56 may be fluidly coupled between drain line 48 and drain line 50. Flow control valve 56 is further fluidly coupled to a consolidated drain line 58 through which the concentrated reject stream may be removed from system 20 (indicated in FIGS. 1 and 2 by arrow 60). Flow control valve 56 is a three-way valve movable between: (i) a first position (shown in FIG. 1) in which valve 56 fluidly couples forward drain line 48 and consolidated drain line 58, while blocking flow through reverse drain line 50, and (ii) a second position (shown in FIG. 2) in which valve 56 fluidly couples reverse drain line 50 and consolidated drain line 58, while blocking flow through forward drain line 48. Thus, by commanding flow control valve 56 to move between the first and second positions, a portion of the reject stream discharged by the final filter unit 24 in flow series can be withdrawn from system 20 immediately downstream of filter units 24, regardless of the particular mode in which flow-reversing subsystem 26 is operating. The appropriate commands can be issued by a controller operably coupled to the actuator of valve 56, such as central controller 62 described below. Any three-way valve suitable for selectively coupling drain lines 48, 50, and 58 may be utilized for this purpose including, but not limited to, L-valves and ball valves. In further embodiments, flow control valve 56 may be replaced by two two-way valves, which are controlled to selectively allow fluid flow through drain lines 48 and 50 in the above-described manner. If desired, a rotameter 64 may be positioned in consolidated drain line 58 to provide a flow rate readout for the concentrated reject stream withdrawn from system 20, as generally shown in FIGS. 1 and 2.

Flow-reversing subsystem 26 can include any number and type of components capable of pressurizing the fluid within reversible flow loop 22 to selectively flow in a forward flow direction (FIG. 1) and in a reverse flow direction (FIG. 2), depending upon the current operational mode of subsystem 26. Flow-reversing subsystem 26 is preferably pump-driven and includes at least one pump, which can be controlled to urge fluid flow within flow loop 22 in the desired direction. In preferred embodiment, flow-reversing subsystem 26 includes two pumps, which are position in reversible flow loop 22 and fluidly coupled in series. For example, as shown in FIGS. 1 and 2, flow-reversing subsystem 26 may include a forward flow pump 66 and a reverse flow pump 68, which are positioned in reversible flow loop 22 such that blending tee 22(a) and filter units 24 are fluidly coupled between pumps 66 and 68. When energized or otherwise driven, forward flow pump 66 urges fluid flow in the forward flow direction (FIG. 1), while reverse flow pump 68 remains quiescent (whether inactivated or in a low-power state) and allows fluid backflow therethrough (the motor of pump 68 may rotate in reverse or freewheel during this period). Conversely, reverse flow pump 68 (when energized) urges fluid flow in the reverse flow direction (FIG. 2), while forward flow pump 66 remains quiescent and allows fluid backflow therethrough. Central controller 62, which is operably coupled to pumps 66 and 68 by control lines 70 and 72, respectively, can thus selectively energize pumps 66 and 68 to achieve the desired flow direction as determined by the particular operational mode of flow-reversing subsystem 26. Notably, as feed stream source 32 provides the feed stream under pressure, pumps 66 and 68 need not further pressurize the feed stream and may simply urge the feed stream to flow in either the forward flow or the reverse flow direction, as the case may be.

Controller 62 preferably controls pumps 66 and 68 to provide a gradual transition between the forward flow and reverse flow modes. Thus, when transitioning from the forward flow mode (FIG. 1) to the reverse flow mode (FIG. 2), controller 62 may control forward flow pump 66 to gradually decrease its output, while simultaneously controlling reverse flow pump 68 to gradually increase its output. Similarly, when returning to the forward flow mode (FIG. 1) from the reverse flow mode (FIG. 2), controller 62 control reverse flow pump 68 to gradually decrease its output, while simultaneously controlling forward flow pump 66 to gradually increase its output. For example, controller 62 may control one pump to increase its output in accordance with a predetermined progressive linear function, while controlling the other pump to decrease its output in accordance with a predetermined degressive linear function, which may be an inverse of the progressive liner function. In one embodiment, flow pumps 66 and 68 are driven by Variable Frequency Drives (VFDs) 74 and 76, respectively, which are operably coupled to controller 62 via control lines 70 and 72. In this case, controller 62 may command VFDs 74 and 76 to simultaneously modulate control signals applied to forward flow pump 66 and to reverse flow pump 68 to gradually transition between the forward flow and reverse flow modes in the above-described manner. For example, when transitioning into the reverse flow mode (FIG. 2) from the forward flow mode (FIG. 1), controller 62 may command VFD 74 to gradually reduce the frequency of the signal applied to forward flow pump 66 (e.g., from 60 to 0 hertz), while commanding VFD 76 to gradually increase the applied to reverse flow pump 68 frequency (e.g., from 0 to 60 hertz). In certain embodiments, controller 62 may likewise control main pump 36 through an additional VFD 78, which is operably coupled to controller 62 by a control line 80. Notably, main pump 36 need not be shutdown as flow-reversing subsystem 26 transitions between modes thereby allowing the internal pressure within filter units 24 to be maintained. Finally, as previously indicated, controller 62 may also be operably coupled to and command flow control valve 56 via a control line 82. In this manner, controller 62 can module flow control valve 56 and control pumps 66 and 68, as appropriate to switch between and operate in the modalities of flow-reversing subsystem 26.

While it is possible that controller 62 can be manually commanded to switch between the forward flow and reverse flow modes, it is preferred that controller 62 automatically determines when to cycle between the forward flow and reverse flow modes based upon one or more predetermined criteria. In certain embodiments, controller 62 may monitor system conditions and switch between modes when at least one predetermined threshold has been surpassed. For example, controller 62 may utilize one or more non-illustrated sensors to measure the pressure drop across filter units 24 indicative of filter saturation and switch between modes when the pressure drop surpasses a predetermined threshold. This notwithstanding, it is preferred that controller 62 periodically switches between the forward flow and reverse flow modes in accordance with a predetermined time interval or cycle duration. Thus, controller 62 may command flow-reversing subsystem 26 to operate in the forward flow mode (FIG. 1) for a predetermined time period (e.g., 10 to 30 minutes); command flow-reversing subsystem 26 to transition to the reverse flow mode (FIG. 2) after the predetermined time period has elapsed; then command flow-reversing subsystem 26 to return to the forward flow mode (FIG. 1) after the period has again elapsed; and so on. By continually cycling between the forward flow and reverse flow modes in this manner, the filter elements within filter units 24 can be maintained in a highly clean state for an extended period of time thereby greatly enhancing filter life, as well as improving the energy efficiency, pressure requirements, purification abilities, and other measures of the overall performance of filtration system 20.

The foregoing has thus provided an exemplary embodiment of a filtration system including a bidirectional, flow-reversing subsystem, which can selectively direct the flow of a feed stream through a reversible flow loop in either a forward flow or a reverse flow direction to deter or lessen the build-up of particulate matter, molecular matter, or other contaminants within one or more filter units positioned in the flow loop. While a particular exemplary embodiment was described above to illustrate one manner in which filtration system can be implemented, it is emphasized that the filtration system shown in FIGS. 1 and 2 is provided by way of non-limiting example only and that various modifications can be made to the filtration system without departing from the scope of the present invention. For example, any number of pumps, including a single pump, can be utilized in the flow-reversing subsystem enabling controlled reversal of the feed stream flow direction. Moreover, while the pressurized feed stream source included a main pressurizing pump in the above-described exemplary embodiment, this need not always be the case. Instead, any source suitable for providing a pressurized feed stream may be utilized in the filtration system including, for example, a standpipe, a tank, or another vessel providing a liquid feed stream under a static head pressure. To further emphasize this point, an exemplary embodiment of a filtration system including a static head feed stream source will now be described in conjunction with FIG. 3.

FIG. 3 is a schematic of a liquid filtration system 90, as illustrated in accordance with a further exemplary embodiment of the present invention. As does filtration system 20 described above in conjunction with FIGS. 1 and 2, filtration system 90 includes a reversible flow loop 92, which is formed by a number of fluidly-coupled conduits 92(a)-92(d). A number of filter units 94 are positioned in reversible flow loop 92; e.g., two cross-flow filter units 94(a) and 94(b) may be positioned in flow loop 92 in flow series as shown in FIG. 3. A flow-reversing subsystem 96 is further positioned in flow loop 92 and includes a forward flow pump 98, a reverse flow pump 100, and a controller (not shown). Flow-reversing subsystem 96 is operable in a forward flow mode (shown in FIG. 3) and a reverse flow mode. During operation, filtration system 90 receives a pressurized feed stream from a feed stream source 102 and separates the feed stream into a permeate stream (removed from filter units 94 via permeate conduit 103) and a reject stream. The reject stream discharged by filter unites 94 is removed from system 90 via drain line 104 or drain line 106 depending upon the particular operational mode of flow-reversing subsystem 96. As was previously the case, this may be accomplished through the modulation of a three-way flow control valve 108, which is fluidly coupled between drain line 104, drain line 106, and a communicative drain line 110 through which the reject stream is withdrawn from filtration system 90. In contrast to feed stream source 32 of filtration system 20 (FIGS. 1 and 2), pressurized feed stream source 102 includes a liquid feed stream vessel or tank 112, which is fluidly coupled to an inlet 114 of flow loop 92 by a supply conduit 116. Feed stream tank 112 holds a column of the feed liquid 118 (e.g., contaminated water), which rises above inlet 114 and thus provides a static head pressurizing the feed stream supplied to flow loop 92. Although not shown in FIG. 3, a throttle valve or flow control valve may also be disposed within supply conduit 116 to help control the flow of the liquid feed to flow loop 92, if desired.

The foregoing has thus described multiple embodiments of filtration systems including pump-driven, flow-reversing subsystems, which can controllably reverse the flow of a feed stream supplied to one or more filters units positioned in a flow loop. In so doing, the flow-reversing subsystem help minimizes debris accumulation within the filter units during operation of the filtration system to prolong filter element life, increase filter efficacy, and improve the overall efficiency of the filtration system. In preferred embodiments, the flow-reversing subsystem transitions between forward flow and reverse flow modes without reliance of valves of the type utilized by conventional backflushing systems to accomplish the desired flow reversal. This, in turn, allows the total number of valves within the filtration system to be reduced to bring about still further improvements in cost, envelope, part count, and efficiencies. While advantageously utilized within fluid filtration systems and especially water purification systems, it is emphasized that embodiments of the above-described flow-reversing subsystem can also be utilized in conjunction with fluid-driven or working-fluid devices other than filtration systems. Such fluid-driven devices may include, but are not limited to, certain types of mining equipment. Thus, the flow-reversing subsystem is not limited to a particular application or usage unless otherwise specified by the appended claims.

Although largely described above in conjunction with filtration systems, it should be appreciated that the teachings of the present invention also encompass methods for separating feed streams into permeate streams and reject streams. In one embodiment, the method includes the step or process of controlling one or more pumps to direct a feed stream around a reversible flow loop in which one or more filter units are positioned in a forward flow direction, while collecting a permeate stream from the filter units and while withdrawing the reject stream from the reversible flow loop at a first location. The one or more pumps are further controlled to reverse the direction of the feed stream flow around the reversible flow loop in in a reverse flow direction, while continuing to collect the permeate stream from the filter units and while withdrawing the reject stream from the reversible flow loop at a second location different than the first location. In certain implementations, the method may also include the step or process of controlling the pumps to periodically alternate between conducting the feed stream through the reversible in a forward flow direction and in a reverse flow direction in accordance with a predetermined mode duration. In certain cases, the one or more pumps may be controlled continually cycle between conducting the feed stream through the reversible flow loop in a forward flow direction and conducting the feed stream through the reversible flow loop in a reverse flow direction in accordance with a predetermined time period.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

What is claimed is:

1. A filtration system, comprising:
a reversible flow loop having an inlet configured to receive a pressurized feed stream;
at least one filter unit positioned in the reversible flow loop and configured to separate the pressurized feed stream into a permeate stream and a reject stream; and
a flow-reversing subsystem positioned in the reversible flow loop and operable in: (i) a forward flow mode wherein the flow-reversing subsystem pressurizes the feed stream to flow through the reversible flow loop in a forward flow direction, and (ii) a reverse flow mode wherein the flow-reversing subsystem pressurizes the feed stream to flow through the reversible flow loop in a reverse flow direction opposite the forward flow direction.

2. The filtration system of claim 1 wherein the flow-reversing subsystem is configured to periodically cycle between the forward flow mode and reverse flow mode at a predetermined time interval.

3. The filtration system of claim 1 further comprising:
a first drain line fluidly coupled to reversible flow loop and removing a portion of the reject stream discharged by the at least one filter unit when the flow-reversing subsystem operates in the forward flow mode; and
a second drain line fluidly coupled to reversible flow loop and removing a portion of the reject stream discharged by the at least one filter unit when the flow-reversing subsystem operates in the revers flow mode.

4. The filtration system of claim 3 further comprising:
a flow control valve fluidly coupled between the first and second drain lines, the flow control valve movable between: (i) a first position wherein the flow control valve permits fluid flow through the first drain line, while blocking fluid flow through the second drain line, and (ii) a second position wherein the flow control valve permits fluid flow through the second drain line, while blocking fluid flow through the first drain line; and
a controller operably coupled to the flow control valve, the controller commanding the flow control valve to move into the first position when the flow-reversing subsystem operates in the forward flow mode and to move into the second position when the flow-reversing subsystem operates in the reverse flow mode.

5. The filtration system of claim 1 wherein the reversible flow loop further comprises a blending tee in which the inlet of the reversible flow loop is formed, the reject stream discharged by the at least one filter unit continually mixed with the pressurized feed stream at the blending tee during operation of the filtration system.

6. The filtration system of claim 5 wherein the flow-reversing subsystem comprises at least one pump fluidly coupled between the blending tee and the at least one filter unit.

7. The filtration system of claim 1 further comprising a main pump fluidly coupled to the inlet of the reversible flow loop and configured to supply the pressurized feed stream at a predetermined pressure.

8. The filtration system of claim 1 further comprising a liquid feed vessel fluidly coupled to the inlet to the inlet of the reversible flow loop and configured to supply the pressurized feed stream under a static pressure.

9. The filtration system of claim 1 wherein the flow-reversing subsystem comprises:
a forward flow pump fluidly positioned in the reversible flow loop and, when energized, configured to direct the feed stream through the reversible flow loop in the forward flow direction;
a reverse flow pump fluidly positioned in the reversible flow loop and, when energized, configured to direct the feed stream through the reversible flow loop in the reverse flow direction; and
a controller operably coupled to the forward flow pump and to the reverse flow pump, the controller energizing the forward flow pump in the forward flow mode and energizing the reverse flow pump in the reverse flow mode.

10. The filtration system of claim 9 wherein controller controls the forward flow pump to gradually decrease its output, while simultaneously controlling the reverse flow pump to gradually increase its output when the flow-reversing subsystem transitions from the forward flow mode to the reverse flow mode.

11. The filtration system of claim 10 further comprising a Variable Frequency Drive (VFD) operably coupled to the controller, to the forward flow pump, and to the reverse flow pump, and wherein the controller commands the VFD to simultaneously modulate a control signal supplied to the forward flow pump and to the reverse flow pump to gradually transition between the forward flow and reverse flow modes.

12. The filtration system of claim 1 wherein the at least one filter unit comprises:
a vertically-oriented pressure vessel; and
a plurality of reverse osmosis filters contained within the vertically-oriented pressure vessel.

13. The filtration system of claim 1 wherein the flow-reversing subsystem comprises at least one pump positioned in the reversible flow loop and configured to provide valveless transition between the forward flow and reverse flow modes.

14. A flow-reversing subsystem, comprising:
a reversible flow loop having an inlet configured to receive a pressurized feed stream;
a forward flow pump fluidly positioned in the reversible flow loop and, when energized, configured to direct feed stream through the reversible flow loop in a forward flow direction;
a reverse flow pump fluidly positioned in the reversible flow loop and, when energized, configured to direct feed stream through the reversible flow loop in a reverse flow direction substantially opposite the forward flow pump; and
a controller operably coupled to the forward flow pump and to the reverse flow pump, the controller energizing the forward flow pump in the forward flow mode and energizing the reverse flow pump in the reverse flow mode.

15. The flow-reversing subsystem of claim 14 wherein controller controls the forward flow pump to gradually decrease its output, while simultaneously controlling the reverse flow pump to gradually increase its output when the flow-reversing subsystem transitions from the forward flow mode to the reverse flow mode.

16. The flow-reversing subsystem of claim 15 further comprising a Variable Frequency Drive (VFD) operably coupled to the controller, to the forward flow pump, and to the reverse flow pump, and wherein the controller commands the VFD to simultaneously modulate a control signal supplied to the forward flow pump and to the reverse flow pump to gradually transition between the forward flow and reverse flow modes.

17. The flow-reversing subsystem of claim 14 wherein the controller is configured to periodically cycle between the forward flow mode and reverse flow mode at a predetermined time interval.

18. The flow-reversing subsystem of claim 14 wherein the reversible flow loop further comprises a blending tee in which the inlet of the reversible flow loop is formed, the blending tee fluidly coupled between the forward flow pump and the reverse flow pump.

19. A method for separating feed stream into a permeate stream and a reject stream, the method comprising:
directing a feed stream in a first direction around a reversible flow loop in which at least one filter unit is positioned, while collecting a permeate stream from the filter units and while withdrawing the reject stream from the reversible flow loop at a first location; and
controlling one or more pumps to reverse the direction of the feed stream flow around the reversible flow loop, while continuing to collect the permeate stream from the filter units and while withdrawing the reject stream from the reversible flow loop at a second location different than the first location.

20. The method of claim 19 further comprising controlling the one or more pumps to periodically cycle between conducting the feed stream through the reversible flow loop in a forward flow and reverse flow directions at a predetermined time interval.
